(19) United States
(12) Patent Application Publication
(10) Pub. No.: US 2024/0345572 A1
(43) Pub. Date: Oct. 17, 2024

(54) COMPUTER-IMPLEMENTED METHODS, APPARATUS, COMPUTER PROGRAMS, AND NON-TRANSITORY COMPUTER-READABLE STORAGE MEDIUMS

(71) Applicant: ROLLS-ROYCE PLC, London (GB)

(72) Inventors: Kee Khoon LEE, Singapore (SG); Henry KASIM, Singapore (SG); Terence HUNG, Singapore (SG); Jair Weigui ZHOU, Singapore (SG); Rajendra Prasad SIRIGINA, Singapore (SG)

(73) Assignee: ROLLS-ROYCE PLC, London (GB)

(21) Appl. No.: 18/580,364

(22) PCT Filed: Jul. 11, 2022
(86) PCT No.: PCT/EP2022/069215

§ 371 Date: Jan. 18, 2024

(30) Foreign Application Priority Data
Aug. 10, 2021 (GB) 2111490.5

(51) Int. Cl. G05B 23/02

(52) U.S. Cl. CPC G05B 23/0281; G05B 23/0272

(57) ABSTRACT

A computer-implemented method including: receiving a first data set including a plurality of values for a plurality of features; identifying at least a first feature of the first data set that is non-redundant and at least a second feature of the first data set that is redundant; identifying one or more clusters of features in the plurality of features of the first data set, a first cluster of the one or more clusters including at least the first feature and the second feature; and controlling a display to display the first feature and one or more redundant features from the first cluster, the displayed one or more redundant features from the first cluster including the second feature.

### TECHNOLOGICAL FIELD

The present disclosure concerns computer-implemented methods, apparatus, computer programs, and non-transitory computer-readable storage mediums for determining feature importance and redundancy removal.

### BACKGROUND

Systems may generate vast quantities of data during their operation and/or existence. For example, an aerospace propulsion system comprising a gas turbine engine may generate data across a large number of features during operation. When the system operates unexpectedly, a large team of engineers and data scientists may be required to review the data generated by the system and identify the problem and perform corrective actions. Such activity may be time consuming and may result in the system being inoperable until corrective actions are performed. For example, an aerospace propulsion system being inoperable may result in the aircraft being grounded, causing the operator to incur cost and logistical penalties.

### BRIEF SUMMARY

According to a first aspect there is provided a computer-implemented method comprising: receiving a first data set comprising a plurality of values for a plurality of features; identifying at least a first feature of the first data set that is non-redundant and at least a second feature of the first data set that is redundant; identifying one or more clusters of features in the plurality of features of the first data set, a first cluster of the one or more clusters comprising at least the first feature and the second feature; and controlling a display to display the first feature and one or more redundant features from the first cluster, the displayed one or more redundant features from the first cluster comprising the second feature.

The computer-implemented method may further comprise receiving a user input signal comprising data defining a feature redundancy criterion.

Identifying the first feature and the second feature may use the received data defining the feature redundancy criterion.

The computer-implemented method may further comprise receiving a user input signal comprising data requesting that the first feature be removed and that the second feature be retained.

The computer-implemented method may further comprise removing at least the first feature and associated values from the first data set to generate a second data set.

The computer-implemented method may further comprise receiving a user input signal comprising data requesting that the first feature be retained and that the one or more redundant features of the first cluster be removed.

The computer-implemented method may further comprise removing at least the second feature and associated values from the first data set to generate a second data set.

The computer-implemented method may further comprise determining feature importance of at least a subset of the features of the second data set using multiple evaluation criteria.

The computer-implemented method may further comprise performing an action using at least one feature of the second data set and the determined feature importance.

The computer-implemented method may further comprise determining a pareto front of the features of the second data set using the determined feature importance. Performing an action may use at least one feature in the determined pareto front.

Performing an action may comprise performing predictive modelling on the at least one feature and associated values to predict an outcome.

Performing an action may comprise controlling a display to display the at least one feature.

The plurality of features may be features of a physical system.

The plurality of features may be features of a propulsion system.

The plurality of features may be features of a gas turbine engine.

According to a second aspect there is provided an apparatus comprising a controller configured to perform the computer-implemented method as described in any of the preceding paragraphs.

According to a third aspect there is provided a computer program that, when executed by a computer, causes performance of the method as described in any of the preceding paragraphs.

According to a fourth aspect there is provided a non-transitory computer readable storage medium comprising computer readable instructions that, when executed by a computer, cause performance of the method as described in any of the preceding paragraphs.

According to a fifth aspect there is provided a computer-implemented method comprising: receiving a first data set comprising a plurality of values for a plurality of features; removing one or more features and associated values from the first data set to generate a second data set; determining feature importance of at least a subset of the features of the second data set using multiple-evaluation criteria; and performing an action using at least one feature of the second data set and the determined feature importance.

The computer-implemented method may further comprise determining a pareto front of the features of the second data set using the determined feature importance. Performing an action may use at least one feature in the determined pareto front.

Performing an action may comprise performing predictive modelling on the at least one feature and associated values to predict an outcome.

Performing an action may comprise controlling a display to display the at least one feature.

The computer-implemented method may further comprise: identifying at least a first feature of the first data set that is non-redundant and at least a second feature of the first data set that is redundant; identifying one or more clusters of features in the plurality of features of the first data set, a first cluster of the one or more clusters comprising at least the first feature and the second feature; and controlling a display to display the first feature and one or more redundant features from the first cluster, the displayed one or more redundant features from the first cluster comprising the second feature.

The computer-implemented method may further comprise receiving a user input signal comprising data defining a feature redundancy criterion.

Identifying the first feature and the second feature may use the received data defining the feature redundancy criterion.

The computer-implemented method may further comprise receiving a user input signal comprising data requesting that the first feature be removed and that the second feature be retained.

The computer-implemented method may further comprise removing at least the first feature and associated values from the first data set to generate the second data set.

The computer-implemented method may further comprise receiving a user input signal comprising data requesting that the first feature be retained and that the one or more redundant features of the first cluster be removed.

The computer-implemented method may further comprise removing at least the second feature and associated values from the first data set to generate the second data set.

The plurality of features may be features of a physical system.

The plurality of features may be features of a power generation system.

The plurality of features may be features of a gas turbine engine.

According to a sixth aspect there is provided an apparatus comprising a controller configured to perform the computer-implemented method as described in any of the preceding paragraphs.

According to a seventh aspect there is provided a computer program that, when executed by a computer, causes performance of the method as described in any of the preceding paragraphs.

According to an eighth aspect there is provided a non-transitory computer readable storage medium comprising computer readable instructions that, when executed by a computer, cause performance of the method as described in any of the preceding paragraphs.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION

Embodiments will now be described by way of example only, with reference to the Figures, in which:

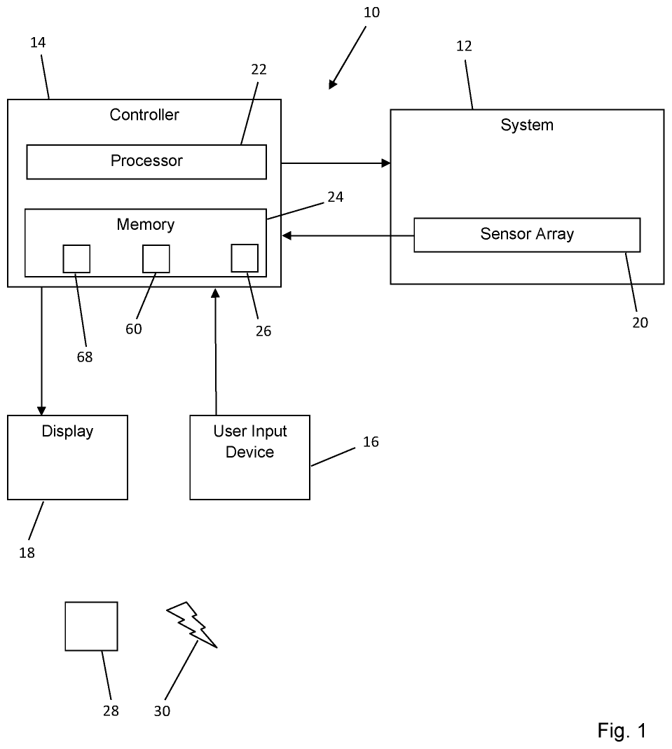

FIG. 1 illustrates a schematic diagram of an apparatus and a system according to various examples;

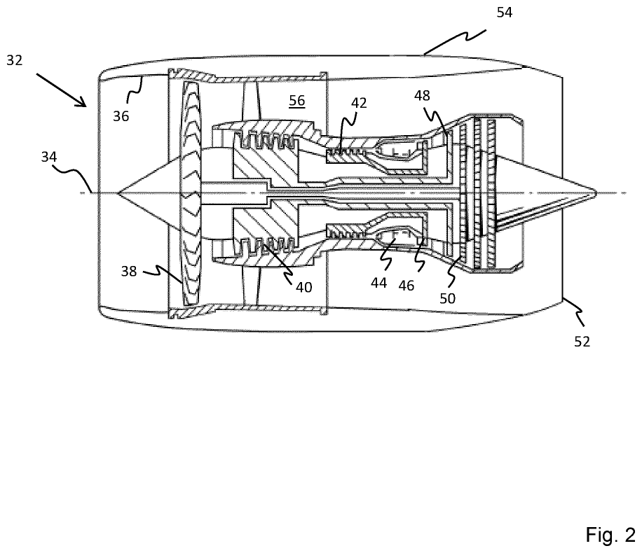

FIG. 2 illustrates a cross sectional side view of a gas turbine engine;

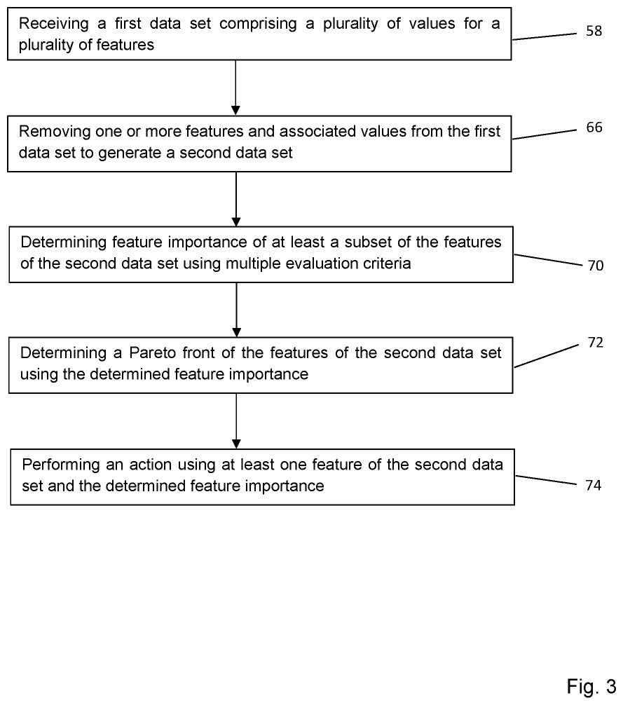

FIG. 3 illustrates a flow diagram of a computer-implemented method of determining feature importance according to various examples;

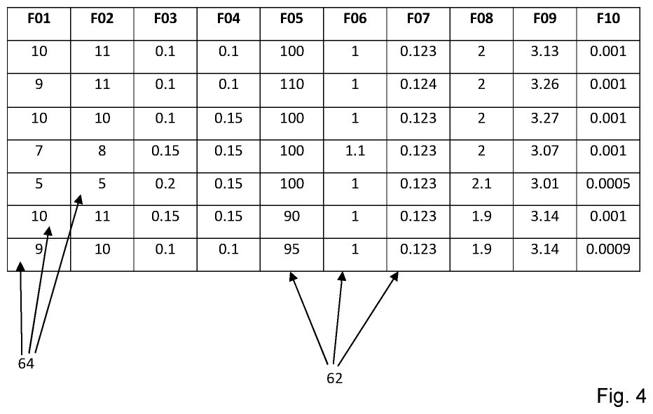

FIG. 4 illustrates a first data set in a tabular format according to an example;

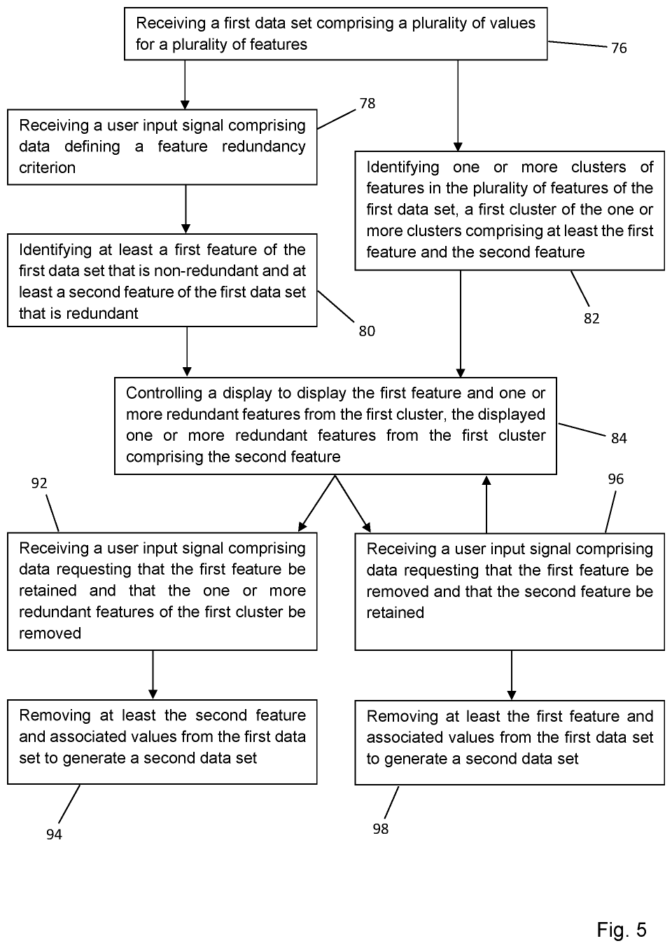

FIG. 5 illustrates a flow diagram of a computer-implemented method of redundancy removal according to various examples;

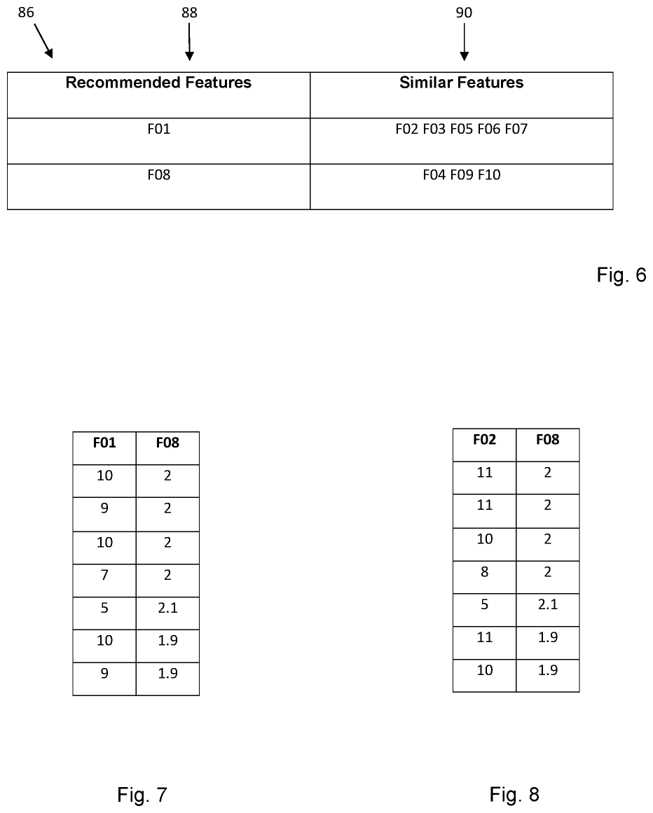

FIG. 6 illustrates a table of non-redundant features and redundant features according to an example;

FIG. 7 illustrates a second data set in a tabular format according to a first example;

FIG. 8 illustrates a second data set in a tabular format according to a second example; and

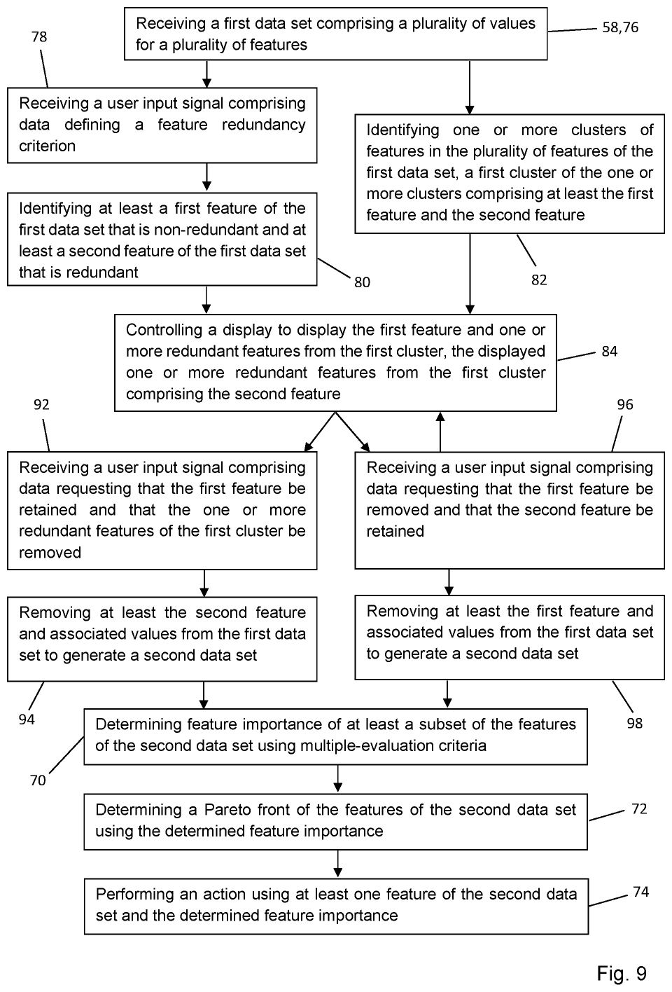

FIG. 9 illustrates a flow diagram of a further computer-implemented method of redundancy removal and determining feature importance according to various examples.

### DETAILED DESCRIPTION

In the following description, the terms ‘connected’ and ‘coupled’ mean operationally connected and coupled. It should be appreciated that there may be any number of intervening components between the mentioned features, including no intervening components.

FIG. 1 illustrates a schematic diagram of an apparatus 10 and a system 12. In summary, the apparatus 10 is configured to receive data from the system 12 and then remove redundant features in the received data. The apparatus 10 may also identify important features in the received data using multiple evaluation criteria and then perform an action using the identified features. For example, the apparatus 10 may schedule maintenance for the system 12, or may upload control data to the system 12 to adapt the operation of the system 12.

The apparatus 10 includes a controller 14, a user input device 16, a display 18 and may include a sensor array 20. In some examples, the apparatus 10 may be a module. As used herein, the wording ‘module’ refers to a device or apparatus where one or more features are included at a later time and, possibly, by another manufacturer or by an end user. For example, where the apparatus 10 is a module, the apparatus 10 may only include the controller 14, and the remaining features (such as the user input device 16, the display 18, and the sensor array 20) may be added by another manufacturer, or by an end user.

The controller 14, the user input device 16, the display 18 and the sensor array 20 may be coupled to one another via a wireless link and may consequently comprise transceiver circuitry and one or more antennas. Additionally, or alternatively, the controller 14, the user input device 16, the display 18 and the sensor array 20 may be coupled to one another via a wired link and may consequently comprise interface circuitry (such as a Universal Serial Bus (USB) socket).

The controller 14 may comprise any suitable circuitry to cause performance of the methods described herein and as illustrated in FIGS. 3, 5 and 9. The controller 14 may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU); and/or a graphics processing unit (GPU), to perform the methods.

The controller 14 may be positioned on, or in the system 12. For example, the controller 14 may comprise one or more dedicated or pre-existing controllers of the system 12. In other examples, the controller 14 may be positioned remotely from the system 12 (for example, in a different city, country, continent, or planet) and may comprise, for example, one or more data centres. In further examples, the controller 14 may be distributed between the system 12 and a location remote from the system 12. For example, the controller 14 may comprise a controller in the system 12, and a data centre positioned remote from the system 12.

The controller 14 may comprise at least one processor 22 and at least one memory 24. The memory 24 stores a computer program 26 comprising computer readable instructions that, when read by the processor 22, causes performance of the methods described herein, and as illustrated in FIGS. 3, 5 and 9. The computer program 26 may be software or firmware, or may be a combination of software and firmware.

The processor 22 may include at least one microprocessor and may comprise a single core processor, may comprise multiple processor cores (such as a dual core processor or a quad core processor), or may comprise a plurality of processors (at least one of which may comprise multiple processor cores).

The memory 24 may be any suitable non-transitory computer readable storage medium, data storage device or devices, and may comprise a hard disk drive (HDD) and/or a solid-state drive (SSD). The memory 24 may be permanent non-removable memory, or may be removable memory (such as a universal serial bus (USB) flash drive or a secure digital card). The memory 24 may include: local memory employed during actual execution of the computer program 26; bulk storage; and cache memories which provide temporary storage of at least some computer readable or computer usable program code 26 to reduce the number of times code may be retrieved from bulk storage during execution of the code.

The computer program 26 may be stored on a non-transitory computer readable storage medium 28. The computer program 26 may be transferred from the non-transitory computer readable storage medium 28 to the memory 24. The non-transitory computer readable storage medium 28 may be, for example, a USB flash drive, a secure digital (SD) card, an optical disc (such as a compact disc (CD), a digital versatile disc (DVD) or a Blu-ray disc). In some examples, the computer program 26 may be transferred to the memory 24 via a signal 30 (such as a wireless signal or a wired signal).

Input/output devices may be coupled to the controller 14 either directly or through intervening input/output controllers. Various communication adaptors may also be coupled to the controller 14 to enable the apparatus 10 to become coupled to other apparatus or remote printers or storage devices through intervening private or public networks. Non-limiting examples include modems and network adaptors of such communication adaptors.

The user input device 16 may comprise any suitable device for enabling an operator to at least partially control the apparatus 10. For example, the user input device 16 may comprise one or more of a keyboard, a keypad, a touchpad, a touchscreen display, and a computer mouse. The controller 14 is configured to receive signals from the user input device 16.

The display 18 is configured to convey information to a user of the apparatus 10. The display 18 may be any suitable type of display and may be, for example, a liquid crystal display, a light emitting diode display, an active matrix organic light emitting diode display, a thin film transistor display, or a cathode ray tube display. The controller 14 is configured to control the display 18 to display information to the user of the apparatus 10.

The sensor array 20 comprises a plurality of sensors that are configured to measure one or more features of the system 12. For example, the sensor array 20 may be configured to measure system features such as pressure, temperature, system component strain and velocity of system components. The controller 14 is configured to receive system feature data from the sensor array 20.

The system 12 may be any group of interacting or interrelated elements that act according to a set of rules to form a unified whole. The system 12 may be a cultural system that is defined by different elements of culture. Alternatively, the system 12 may be an economic system that defines the production, distribution and consumption of goods and services in a particular society, and comprises people, institutions, and their relationships to resources. In other examples, the system 12 may be a physical system such as a propulsion system comprising one or more gas turbine engines, and/or one or more electrical machines, and/or one or more fuel cells. In another example of a physical system, the system 12 may be an information technology (I.T.) system such as a computer hardware system, a computer software system, or a system comprising both computer hardware and computer software. In some examples, the system 12 may be a machine such as a vibro-peening machine, an etching machine, or a polishing machine.

FIG. 2 illustrates a cross sectional side view of a gas turbine engine 32 that may form at least a part of the system 12 in some examples. The gas turbine engine 32 has a principal and rotational axis 34 and comprises, in axial flow series, a plurality of components including an air intake 36, a propulsive fan 38, an intermediate-pressure compressor 40, a high-pressure compressor 42, combustion equipment 44, a high-pressure turbine 46, an intermediate-pressure turbine 48, a low-pressure turbine 50 and an exhaust nozzle 52. A nacelle 54 generally surrounds the gas turbine engine 32 and defines both the intake 36 and the exhaust nozzle 52.

The gas turbine engine 32 operates so that air entering the intake 36 is accelerated by the fan 38 to produce two air flows: a first air flow into the intermediate pressure compressor 40 and a second air flow which passes through a bypass duct 56 to provide propulsive thrust. The intermediate-pressure compressor 40 compresses the air flow directed into it before delivering that air to the high-pressure compressor 42 where further compression takes place.

The compressed air exhausted from the high-pressure compressor 42 is directed into the combustion equipment 44 where it is mixed with fuel and the mixture is combusted. The resultant hot combustion products then expand through, and thereby drive the high, intermediate, and low-pressure turbines 46, 48, 50 before being exhausted through the nozzle 52 to provide additional propulsive thrust. The high-pressure turbine 46, the intermediate-pressure turbine 48 and the low-pressure turbine 50 drive respectively the high-pressure compressor 42, the intermediate-pressure compressor 40 and the fan 38, each by a suitable interconnecting shaft.

Other gas turbine engines to which the present disclosure may be applied may have alternative configurations. By way of example, such gas turbine engines may have an alternative number of interconnecting shafts (two for example) and/or an alternative number of compressors and/or turbines. Furthermore, the gas turbine engine may comprise a gearbox provided in the drive train from a turbine to a compressor and/or fan.

FIG. 3 illustrates a flow diagram of a computer-implemented method for determining feature importance according to various examples.

At block 58, the method includes receiving a first data set comprising a plurality of values for a plurality of features. The controller 14 may receive the first data set from the sensor array 20, the user input device 16, from a remote memory via a wide area network such as the internet, or from a non-transitory computer readable storage medium such as a USB flash drive. The controller 14 may store the first data set in the memory 24 (indicated by the reference numeral 60).

By way of an example where the system 12 comprises a propulsion system, the controller 14 may receive a first data set from the sensor array 20 that comprises a plurality of values for features such as temperature, pressure, shaft rotational velocity and so on.

By way of another example, where the system 12 comprises an information technology (I.T.) system, the controller 14 may receive a first data set from the sensor array 20 that comprises a plurality of values for features such as data transfer rates, central processor unit (CPU) utilisation, electrical power consumption, central processor unit (CPU) temperature, and so on.

In examples where the system 12 may not be measurable using a sensor array 20 (for example, where the system 12 is a cultural system or a social system), the first data set may be obtained by conducting a survey of people (for example, a survey hosted on the internet). Where the system 12 is an economic system, the first data set may be obtained from databases (or other data structures) of the economic system.

FIG. 4 illustrates a first data set in a tabular format according to an example. The first data set comprises ten columns 62 for ten features (F01, F02, F03, F04, F05, F06, F07, F08, F09, F10) of the system 12, and seven rows 64 for seven values of each of the features F01, F02, F03, F04, F05, F06, F07, F08, F09, F10. The plurality of values of a feature may be time-series data (that is, the values of each feature were measured at different times). Additionally, or alternatively, the plurality of values of a feature may be measured at the same time, but from different sources of data (for example, the plurality of values may be measured at the same time by different sensors of the sensor array 20). Additionally, or alternatively, the plurality of values of a feature may be aggregated time series data and in these examples, the feature may be a ‘derived’ feature (where a ‘derived’ feature is defined as an aggregation of the original data (for example, mean, standard deviation (std), kurtosis, fast Fourier transform (FFT) and so on), or a domain specific formula that uses the original data to derive it (for example, different harmonics for an electrical signal). In some examples, the first data set may be a comma-separated values (CSV) file, an OpenDocument file (such as an ODS file) or an Excel Binary File Format (XLS) file.

At block 66, the method includes removing one or more features and associated values from the first data set to generate a second data set. In some examples, the one or more features and associated values may be removed automatically by the controller 14 using a redundancy removal algorithm such as Pearson or Spearman correlation. In other examples, the one or more features and associated values may be removed manually by the user of the apparatus 10. In more detail, the user may view the first data set 60 on the display 18 of the apparatus 10 and identify one or more redundant features using their experience and knowledge of the system 12. The user may then operate the user input device 16 to send a signal to the controller 14 to request that one or more features and their associated values be removed. In further examples, the one or more features and associated values may be removed using a combination of a redundancy removal algorithm and user input.

In some examples, the one or more features and associated values may be removed by the controller 14 using the method illustrated in FIG. 5. The combination of the methods illustrated in FIGS. 3 and 5 is illustrated in FIG. 9 and is described in detail later in the description.

The controller 14 may store the generated second data set in the memory 24 (as indicated by reference numeral 68 in FIG. 1). It should be appreciated that the second data set 68 generated through the execution of block 66 has fewer features (and thus fewer values) than the first data set 60. For example, where the first data set 60 is as illustrated in FIG. 4, the second data set 68 may only include features F01 and F08 (as illustrated in FIG. 7) or features F02 and F08 (as illustrated in FIG. 8).

At block 70, the method includes determining feature importance of at least a subset of the features of the second data set using multiple evaluation criteria. The controller 14 may read the second data set 68 from the memory 24 and then determine the feature importance of at least a subset of the features of the second data set 68 using multiple evaluation criteria such as F-score, T-score, Fisher-score, reliefF-score and trace ratio. The controller 14 may then rank the features of the second data set 68 using the results of the multiple evaluation criteria. While F-score, T-score, Fisher-score, reliefF-score and trace ratio are mentioned above as examples of evaluation criteria, it should be appreciated that in other examples, other evaluation criteria may be used (for example, evaluate linear relationships using least squares and its variants like elasticNet, least angle regression (lars), lasso, ridge regression, and evaluate non-linear relationships using Spearman correlation, Kendall correlation, Mutual Information, and Quadratic Mutual Information, as evaluation criteria at block 70). Additionally, it should be appreciated that in some examples, the controller 14 may determine the feature importance of all features of the second data set 68.

The first data set may have one or more targets and thus comprise two or more classifications. For example, where the system 12 comprises a gas turbine engine, a target may be a predetermined threshold of a feature of the gas turbine engine. The classifications are whether the values of that feature are above or below the predetermined threshold. In some examples, the first data set may not have target for one or more of the features and thus presents an unsupervised problem.

By way of an example, in a binary classification problem, let N and n_{c} be the total number of features, and total number of features in the c-th class respectively. Let fᵢ, f_{i,c}, f^{k}_{i,c}, μᵢ, σᵢ, μ_{i,c}, σ_{i,c}, where i={1, . . . , N}, c={1,2}, be the i-th feature, i-th feature in c-th class, i-th feature that belongs to k-th instance of c-th class, mean and variance of i-th feature, and mean and variance of i-th feature in c-th class, respectively. Let F(fᵢ), T(fᵢ), Fisher(fᵢ), reliefF(fᵢ) and trace ratio(fᵢ) be the F-score, T-score, Fisher-score, reliefF-score, and trace ratio of the feature fᵢ, respectively.

By way of an example, F(fᵢ) is defined as:

$$F ( {f}_{i} ) = \frac{{\sum }_{c = 1}^{2} {( {μ}_{i , c} - {μ}_{i} )}^{2}}{{\sum }_{c = 1}^{2} \frac{1}{{n}_{c} - 1} {\sum }_{k = 1}^{{n}_{c}} {( {f}_{i , c}^{k} - {μ}_{i , c} )}^{2}} \qquad ( 1 )$$

The F-score is used to determine how well a feature can discriminate two sets of real numbers, and a high F-score means the discrimination power of the feature is high (that is, a higher F-score means a higher feature importance).

By way of another example, T(fᵢ) is defined as:

$$T ( {f}_{i} ) = \frac{\vert {μ}_{i , 1} - {μ}_{i , 2} \vert}{\sqrt{\frac{{σ}_{i , 1}^{2}}{{n}_{1}} + \frac{{σ}_{i , 2}^{2}}{{n}_{2}}}} \qquad ( 2 )$$

A feature with a high T-score means average values of two classes in a binary classification problem are statistically different (that is, a higher T-score means a higher feature importance).

By way of a further example, Fisher(fᵢ) is defined as:

$$Fisher ( {f}_{i} ) = \frac{{\sum }_{c = 1}^{2} {{n}_{c} ( {μ}_{i , c} - {μ}_{i} )}^{2}}{{\sum }_{c = 1}^{2} {n}_{c} {σ}_{i , c}^{2}} \qquad ( 3 )$$

A higher Fisher-score means a higher feature importance.

The evaluation criteria used may depend on the class of the target. For example, a binary classification problem may be evaluated using T_score, a multiple class problem may be evaluated using Fisher-score, reliefF, trace ratio and F-score, a linear regression problem may be evaluated using elasticNet, lars, lasso, least square regression, and ridge, and a non-linear regression problem may be evaluated using Spearman correlation coefficient, Kendall correlation coefficient, Mutual Information and Quadratic Mutual Information.

At block 72, the method may include determining a Pareto front of the features of the second data set using the determined feature importance. For example, the controller 14 may determine a Pareto front of the features of the second data set 68 using the feature importance values determined at block 70. Where the feature importance has been determined for only a subset of the features of the second data set (that is, where the number of features having feature importance values is less than the total number of features in the second data set), block 72 may include determining a Pareto front for only those features having feature importance values. The combination of blocks 70 and 72 may be referred to as ‘Multiple Evaluation Criteria and Pareto’ (MECP).

In some examples, blocks 70 and 72 may be performed using the pseudo code in the following algorithm.

Algorithm - Blocks 70 and 72:

Input:
D ∈ R^{I x N}: Second data set (where I and N denote number of instances and
features, respectively)
Output:
F_{S}: Ordered unique feature subset at Pareto layer 0

| 1. | procedure MECP(D: Second data set) | |
|---|---|---|
| 2. | F₀ <− ϕ | # Set of features in Pareto layer 0 |
| 3. | for k = 1 to K do | # K-fold cross-validation |
| 4. | D_{K-1} = SSD | # Data from K−1 folds of Stratified Shuffle Shift (SSD) |
| 5. | for s = 1 to S do | # Five feature scores (S=5) |

| 6. | for i=1 to N do | |
|---|---|---|
| 7. | f_{i,k} <− D_{K-1}(i) | # i-th feature vector |
| 8. | G_{[i]} <− ϕₛ(f_{i,k}) | # Calculation of feature importance |

score of i-th feature at k-th fold

| 9. | end for | |
|---|---|---|
| 10. | Ĝ <− SORT(G) | # Sort features based on s-th feature |

score

| | | |
|---|---|---|
| 11. | F₀ <− F₀ U Ĝ[1] | # Select top feature |

| 12. | end for | |
|---|---|---|
| 13. | end for | |
| 14. | F_{S} <− RANK(F₀) | # Rank the features based on the number of times they |

appeared in F₀

| | |
|---|---|
| 15. | end procedure |

Let ϕₛ=(⋅), s={1, . . . , 5}, denote the functions F(⋅), T(⋅), Fisher(⋅), reliefF(⋅), and trace ratio(⋅). Let K=10 and S=5 denote the number of folds for cross-validation and number of feature scores, respectively. At each fold, the feature scores are calculated and arranged in decreasing order of their rank. Top feature from each feature score is added to feature set F₀ of pareto layer 0. The features in F₀ are ranked based on the frequency with which the features appeared. For example, top ranked feature at layer 0 is selected the greatest number of times by feature scores at each fold. The algorithm returns the feature subset F_{S}, that contains features and their ranks.

At block 74, the method includes performing an action using at least one feature of the second data set and the determined feature importance. For example, the controller 14 may control the display 18 to display one or more features of the second data set 68.

Where the method includes block 72, the controller 14 may control the display 18 to display one or more features in the Pareto front of the second data set 68 (for example, one or more features in the feature subset F_{S} generated by the above mentioned algorithm). In this example, block 74 indirectly uses the determined feature importance since the one or more features to be displayed are taken from the Pareto front which is determined at block 72 using the feature importance determined at block 70.

Where the method does not include block 72, the controller 14 may control the display 18 to display some or all of the features of the second data set 68 and their feature importance. For example, the controller 14 may order the features of the second data set 68 from highest feature importance to lowest feature importance and then control the display 18 to display the ordered features (for example, features with highest feature importance at the top of the display 18, and features with lowest feature importance at the bottom of the display 18). The features may be displayed alongside their feature importance, or an indication of their relative feature importance (for example, high importance, medium importance, low importance).

A user of the apparatus 10 may view the display 18 to understand which features of the system 12 are of highest importance. Using their knowledge of the system 12 and the features identified as having high importance, the user may then schedule maintenance for the system 12. For example, where a feature indicated as having a high importance is a feature associated with the low-pressure compressor 40 of the gas turbine engine 32, the user may schedule inspection and/or maintenance for the low-pressure compressor 40. The user may also use their knowledge of the system 12 and the features identified as having high importance to prepare and upload control data to the system 12 to adapt the operation of the system 12. For example, where a feature indicated as having a high importance is a feature associated with the combustion equipment 44 of the gas turbine engine 32, the user may prepare and upload control data for the combustion equipment 44 to the electronic engine controller (EEC) or the full authority digital engine controller (FADEC) of the gas turbine engine 32.

It should be appreciated that in some examples, the actions mentioned above (such as scheduling inspection, maintenance, and the preparation and uploading of control data to the system 12) may be performed by the controller 14 instead of the user. For example, the controller 14 may use a look-up table or a trained artificial intelligence to assess the features (and their associated values) identified as having high importance to determine, and then perform, actions on the system 12.

The controller 14 may perform predictive modelling on the at least one feature and associated values at block 74 to predict an outcome for the system 12. For example, the controller 14 may enter a high importance feature and its associated values into a predictive model stored in the memory 24 to predict an outcome for the system 12. A user of the apparatus 10, or the controller 14, may use the predicted outcome to perform one of the actions mentioned above (for example, scheduling inspection, maintenance, and the preparation and uploading of control data to the system 12).

The method illustrated in FIG. 3 may provide several advantages. In particular, the method may identify features of a system 12 that are important and then enable further investigation and/or corrective action to be performed. The method may be particularly beneficial in examples where the system 12 is a complex system having a large number of features (such as a system comprising a gas turbine engine) that may be too large for humans to assess in a time and cost effective manner. Additionally, the method may be advantageous in that block 66 may remove redundant features from the first data set to generate the second data set. This reduction in dimensionality of the data set may enable the downstream method to be performed more quickly and/or using fewer computing resources.

FIG. 5 illustrates a flow diagram of a method for redundancy removal according to various examples.

At block 76, the method includes receiving a first data set comprising a plurality of values for a plurality of features. Block 76 may be the same as, or similar to, block 58 illustrated in FIG. 3 and discussed above. Consequently, the controller 14 may receive the first data set from the sensor array 20, the user input device 16, a remote memory via a wide area network such as the internet, or from a non-transitory computer readable storage medium such as a USB flash drive. The controller 14 may store the first data set in the memory 24 (indicated by the reference numeral 60).

By way of an example where the system 12 comprises a propulsion system, the controller 14 may receive a first data set from the sensor array 20 that comprises a plurality of values for features such as temperature, pressure, shaft rotational velocity and so on.

By way of another example, where the system 12 comprises an information technology (I.T.) system, the controller 14 may receive a first data set from the sensor array 20 that comprises a plurality of values for features such as data transfer rates, central processor unit (CPU) utilisation, electrical power consumption, central processor unit (CPU) temperature, and so on.

In examples where the system 12 may not be measurable using a sensor array 20 (for example, where the system 12 is a cultural system or a social system), the first data set may be obtained by conducting a survey of people (for example, a survey hosted on the internet). Where the system 12 is an economic system, the first data set may be obtained from databases (or other data structures) of the economic system.

In the following description, the method is described with reference to the first data set illustrated in FIG. 4. However, it should be appreciated that in other examples of the method of FIG. 5, the first data set may be different to the one illustrated in FIG. 4.

At block 78, the method may include receiving a user input signal comprising data defining a feature redundancy criterion. For example, the controller 14 may control the display 18 to display a prompt to the user to enter or select the desired number of features for the second data set 68 (a feature redundancy criterion). In another example, the controller 14 may control the display 18 to display a prompt to the user to enter or select a threshold variance inflation factor (VIF—a feature redundancy criterion). The user of the apparatus 10 may then operate the user input device 16 to select or input a desired number of features for the second data set, or a threshold variance inflation factor. The controller 14 subsequently receives data from the user input device 16 comprising the desired number of features for the second data set, or a threshold variance inflation factor.

In some examples, the method may not include block 78 and instead, a feature redundancy criterion is predetermined and stored in the memory 24. For example, a desired number of features for the second data set, or a threshold variance inflation factor, may be predetermined and stored in the memory 24.

At block 80, the method includes identifying at least a first feature of the first data set that is non-redundant (for example, feature F01 illustrated in FIG. 4) and at least a second feature of the first data set that is redundant (for example, feature F02 illustrated in FIG. 4). The controller 14 may read the first data set 60 from the memory 24 and filter features with zero variance. Next, the controller 14 may calculate the variance inflation factor of the features of the first data set 60 (minus any filtered features). The controller 14 then determines whether the first data set 60 complies with the feature redundancy criterion. For example, the controller 14 may determine whether the variance inflation factor of the first data set 60 is less than a threshold variance inflation factor. In another example, the controller 14 may determine whether the number of features in the data set is equal to or less than a desired number of features. Where the controller 14 determines that the first data set 60 does not comply with the feature redundancy criterion, the controller 14 identifies the feature of the first data set 60 having the largest variance inflation factor as being redundant. The controller 14 then iteratively repeats the process by recalculating the variance inflation factor of the first data set (minus any features that were filtered, and those features identified as being redundant). Once the first data set 60 complies with the feature redundancy criterion, the first data set 60 comprises one or more features identified as non-redundant (including the first feature mentioned above), and one or more features identified as redundant (including the second feature mentioned above).

In some examples, the controller 14 may control the display 18 to display the features of the first data set 60 as a scree plot. The cumulative percent of variance is on the Y axis and the order of discarded features is on the X axis. The plot includes a vertical line for the recommended threshold point (demarcating those features determined to be redundant from those features determined to be non-redundant). The user of the apparatus 10 may operate the user input device 16 to move the position of the vertical line along the X axis to change the subset of features that are redundant and consequently, the subset of features that are non-redundant.

At block 82, the method includes identifying one or more clusters of features in the plurality of features of the first data set, where a first cluster of the one or more clusters comprises at least the first feature and the second feature. For example, the controller 14 may use a clustering algorithm (such as a modified partition around medoids (mPAM) algorithm, or k-means clustering) to identify the one or more clusters of features in the plurality of features of the first data set 60. Block 82 may be performed in parallel to blocks 78 and 80 as illustrated in FIG. 5.

Alternatively, block 82 may be performed in series with blocks 78 and 80, and may be performed, for example, after block 80.

In the example where the first data set 60 is as illustrated in FIG. 4, the first cluster may include the (non-redundant) feature F01 and the (redundant) features F02, F03, F05, F06 and F07. A second cluster may include the (non-redundant) feature F08 and the (redundant) features F04, F09, and F10.

At block 84, the method includes controlling a display to display the first feature and the one or more redundant features from the first cluster, where the displayed one or more redundant features from the first cluster comprises the second feature. For example, the controller 14 uses the outputs from blocks 80 and 82 and controls the display 18 to display the first feature (for example, as a ‘recommended feature’) and the redundant features in the first cluster (including the second feature). Concurrently, or at a later time, the controller 14 controls the display 18 to display the non-redundant features and redundant features of the other clusters identified at block 82 (either sequentially or concurrently).

In the example where the first data set 60 is as illustrated in FIG. 4, the controller 14 may control the display 18 to display a table 86 as illustrated in FIG. 6. The table 86 includes a first column 88 for ‘Recommended Features’ (that is, features identified as non-redundant at block 80), a second column 90 for ‘Similar Features’ (that is, features identified as redundant at block 80), and rows that represent clusters determined at block 82. In the first column 88 of a first row, the table 86 includes the feature F01, and in the second column 90 of the first row, the table 86 includes the features F02, F03, F05, F06, F07. In the first column 88 of a second row, the table 86 includes the feature F08, and in the second column 90 of the second row, the table 86 includes the features F04, F09, F10.

The display of the non-redundant features and redundant features identified at block 80 advantageously enables the user of the apparatus 10 to understand which features need not be analysed to further assess and act on the system 12. This reduction in dimensionality of the data set may enable the further analysis of the data to be performed more quickly and/or using fewer computing resources.

Where the user of the apparatus 10 wishes to retain the first feature, the method moves to block 92.

At block 92, the method may include receiving a user input signal comprising data requesting that the first feature be retained and that the one or more redundant features of the first cluster be removed. For example, the user of the apparatus 10 may view the display 18 and decide that they wish to retain the first feature which has been identified as non-redundant for the first cluster. The user may then operate the user input device 16 to provide data to the controller 14 to request that the first feature be retained. In the example illustrated in FIG. 6, the user may operate the user input device 16 to select the feature F01 and the controller 14 subsequently receives a user input signal comprising data requesting that feature F01 be retained.

It should be appreciated that the method may not include block 92. For example, the features identified as being non-redundant may be automatically retained by the controller 14 where a predetermined period of time expires without the controller 14 receiving a request from the user input device 16.

At block 94, the method includes removing at least the second feature and associated values from the first data set to generate a second data set. For example, the controller 14 may use the user input signal received at block 92 to generate a second data set that does not comprise the features determined to be redundant. The controller 14 may store the second data set in the memory 24 (indicated by reference numeral 68 as mentioned above).

In the example illustrated in FIG. 6, the controller 14 may generate a second data set as illustrated in FIG. 7. In more detail, the second data set illustrated in FIG. 7 includes a first column for the feature F01 and the values of the feature F01, and a second column for the feature F08 and the values of the feature F08. It should be noted that the second data set illustrated in FIG. 7 does not comprise the features (and associated values) determined to be redundant (that is, the second data set does not comprise the features F02, F03, F04, F05, F06, F07, F09, F10).

Where the user of the apparatus 10 wishes to swap the first feature with another feature from the first cluster (for example, because they are more familiar with working with another feature of the first cluster, or because the first feature is too abstract for the user), the method moves to block 96.

At block 96, the method may include receiving a user input signal comprising data requesting that the first feature be removed and that the second feature be retained. For example, the user of the apparatus 10 may view the display 18 and decide that they wish to swap the first feature (which has been identified as non-redundant for the first cluster) with the second feature (which has been identified as redundant for the first cluster). The user may then operate the user input device 16 to provide data to the controller 14 to request that the first feature be swapped with the second feature. In the example illustrated in FIG. 6, the user may operate the user input device 16 to select the feature F02 (for example, by dragging F02 across to the ‘Recommended Features’ column 88) and the controller 14 subsequently receives a user input signal comprising data requesting feature F02.

In some examples, the method may return to block 84 and the controller 14 may control the display 18 to display an updated table (or other user interface element) to reflect the user's selection at block 96 (for example, feature F02 is now displayed in column 88 as one of the ‘recommended features’, and feature F01 is displayed in column 90 as one of the ‘similar features’).

At block 98, the method may include removing at least the first feature and associated values from the first data set to generate a second data set. For example, the controller 14 uses the user input signal received at block 96 to generate a second data set that does not comprise the first feature and the features determined to be redundant at block 80. The controller 14 may store the second data set in the memory 24 (indicated by reference numeral 68 as mentioned above).

In the example illustrated in FIG. 6, the controller 14 may generate a second data set as illustrated in FIG. 8. In more detail, the second data set illustrated in FIG. 8 includes a first column for the feature F02 and the values of the feature F02, and a second column for the feature F08 and the values of the feature F08. It should be noted that the second data set illustrated in FIG. 8 does not comprise the first feature and the features determined to be redundant at block 80 (that is, features F01, F03, F04, F05, F06, F07, F09, F10).

Subsequent to blocks 94 and 98, the controller 14 may control the display 18 to display the second data set 68 to enable viewing by the user of the apparatus 10.

Blocks 84, 92, 94, 96 and 98 may be advantageous in that they enable the user of the apparatus 10 to view the recommended and similar features, and then swap features recommended by the apparatus 10 with similar features they may be more experienced in understanding and taking further action on.

FIG. 9 illustrates a flow diagram of a computer-implemented method of redundancy removal and determining feature importance according to various examples. The method illustrated in FIG. 9 is a combination of the method illustrated in FIG. 3 (determining feature importance) and the method illustrated in FIG. 5 (redundancy removal), and where the blocks are the same or similar, the same reference numerals are used.

In summary, at block 58/76, the method comprises receiving a first data set 60 comprising a plurality of values for a plurality of features of the system 12. At block 78, the method may include receiving a user input signal comprising data defining a feature redundancy criterion. At block 80, the method includes identifying at least a first feature of the first data set that is non-redundant and at least a second feature of the first data set that is redundant. At block 82, the method includes identifying one or more clusters of features of the first data set 60, a first cluster of the one or more clusters comprising at least the first feature and the second feature. At block 84, the method includes using the output from blocks 80 and 82 to control a display 18 to display the first feature and one or more redundant features from the first cluster, the displayed one or more redundant features from the first cluster comprising the second feature.

At block 92, the method may include receiving a user input signal comprising data requesting that the first feature be retained and that the one or more redundant features of the first cluster be removed. At block 94, the method may include removing at least the second feature and associated values from the first data set to generate a second data set 68.

Alternatively, at block 96, the method may include receiving a user input signal comprising data requesting that the first feature be removed and that the second feature be retained. At block 98, the method may include removing at least the first feature and associated values from the first data set to generate a second data set 68.

At block 70, the method includes determining feature importance of at least a subset of the features of the second data set 68 generated at block 94 or 98 using multiple-evaluation criteria. At block 72, the method may include determining a Pareto front of the features of the second data set using the determined feature importance. At block 74, the method includes performing an action using at least one feature of the second data set 68 and the determined feature importance.

The method illustrated in FIG. 9 may advantageously provide a means to confidently tackle complex, data-intensive problems and root-cause analyses in various systems in a data-driven manner. Where the input data does not comprise a target variable (unsupervised problem), redundancy removal may enable the user to leverage domain expertise and/or prior knowledge, improve explainability/traceability, and increase confidence in identifying relevance feature data sets. Where the input data comprises a target variable (supervised problem), redundancy removal and MECP may be used together to identify and recommend a “shortlist” of relevant features, wherein the target may be binary, multi-category, and regression in nature.

It will be understood that the invention is not limited to the embodiments above described and various modifications and improvements can be made without departing from the concepts described herein. For example, the different embodiments may take the form of an entirely hardware embodiment, an entirely software embodiment, or an embodiment containing both hardware and software elements.

Except where mutually exclusive, any of the features may be employed separately or in combination with any other features and the disclosure extends to and includes all combinations and sub-combinations of one or more features described herein.

1. A computer-implemented method comprising:
receiving a first data set comprising a plurality of values for a plurality of features;
identifying at least a first feature of the first data set that is non-redundant and at least a second feature of the first data set that is redundant;
identifying one or more clusters of features in the plurality of features of the first data set, a first cluster of the one or more clusters comprising at least the first feature and the second feature; and
controlling a display to display the first feature and one or more redundant features from the first cluster, the displayed one or more redundant features from the first cluster comprising the second feature.

2. The computer-implemented method as claimed in claim 1, further comprising receiving a user input signal comprising data defining a feature redundancy criterion.

3. The computer-implemented method as claimed in claim 2, wherein identifying the first feature and the second feature uses the received data defining the feature redundancy criterion.

4. The computer-implemented method as claimed in claim 1, further comprising receiving a user input signal comprising data requesting that the first feature be removed and that the second feature be retained.

5. The computer-implemented method as claimed in claim 4, further comprising removing at least the first feature and associated values from the first data set to generate a second data set.

6. The computer-implemented method as claimed in claim 1, further comprising receiving a user input signal comprising data requesting that the first feature be retained and that the one or more redundant features of the first cluster be removed.

7. The computer-implemented method as claimed in claim 1, further comprising removing at least the second feature and associated values from the first data set to generate a second data set.

8. The computer-implemented method as claimed in claim 5, further comprising: determining feature importance of at least a subset of the features of the second data set using multiple evaluation criteria.

9. The computer-implemented method as claimed in claim 8, further comprising performing an action using at least one feature of the second data set and the determined feature importance.

10. The computer-implemented method as claimed in claim 9, further comprising determining a pareto front of the features of the second data set using the determined feature importance, and wherein performing an action uses at least one feature in the determined pareto front.

11. The computer-implemented method as claimed in claim 9, wherein performing an action comprises performing predictive modelling on the at least one feature and associated values to predict an outcome.

12. The computer-implemented method as claimed in claim 9, wherein performing an action comprises controlling a display to display the at least one feature.

13. The computer-implemented method as claimed in claim 1, wherein the plurality of features are features of a physical system.

14. The computer-implemented method as claimed in claim 1, wherein the plurality of features are features of a propulsion system.

15. The computer-implemented method as claimed in claim 1, wherein the plurality of features are features of a gas turbine engine.

16. An apparatus comprising a controller configured to perform the computer-implemented method as claimed in claim 1.

17. (canceled)

18. A non-transitory computer readable storage medium comprising computer readable instructions that, when executed by a computer, cause performance of the method as claimed in claim 1.
